(19) United States
(12) Patent Application Publication
(10) Pub. No.: US 2007/0145723 A1
(43) Pub. Date: Jun. 28, 2007

(54) Vertically adjustable folding wheelchair

(76) Inventor: Jemimah G. Kamara, Garland, TX (US)

Correspondence Address: LAW OFFICES OF ERIC KARICH, 2807 ST. MARK DR., MANSFIELD, TX, 76063, US

(21) Appl. No.: 11/367,920

(22) Filed: Mar. 3, 2006

Related U.S. Application Data
(60) Provisional application No. 60/740,341, filed on Nov. 29, 2005.

(51) Int. Cl. B62B 1/00

(52) U.S. Cl. 280/647

(57) ABSTRACT

A vertically adjustable folding wheelchair has a pair of base elements, a pair of longitudinal frame members, and first and second telescoping elements. Wheels rotatably support the pair of base elements. The first and second telescoping elements telescopically engage each of the base elements with one of the longitudinal frame members. A lifting element functions to move the pair of longitudinal frame members, and a seat attached thereto, between a lowered configuration and a raised configuration. A folding frame supports the pair of base elements in a laterally spaced relationship while folding between an expanded configuration and a folded configuration.

### CROSS-REFERENCE TO RELATED APPLICATIONS

This application for a utility patent claims the benefit of U.S. Provisional Application No. 60/740,341, filed Nov. 29, 2005.

### STATEMENT REGARDING FEDERALLY SPONSORED RESEARCH

Not Applicable

### BACKGROUND OF THE INVENTION

1. Field of the Invention

This invention relates generally to wheelchairs, and more particularly to a vertically adjustable folding wheelchair.

2. Description of Related Art

The following art defines the present state of this field:

Wing, U.S. Pat. No. 6,793,232, teaches a wheelchair that includes a support frame, at least two main wheels mounted on sides of the support frame, and a seat base disposed upon a laterally slidable storage compartment that may be affixed to the support frame. The storage compartment and a potty panel allow for evacuation of the patient while resting in the wheelchair. The seat base is configured for selectively raising and lowering the patient between first and second levels, and the seat back and leg supports can also be raised and lowered between vertical and horizontal orientations. The wheelchair cannot, however, be used as a manual wheelchair, and it cannot be collapsed when not in use.

Robbins, U.S. Pat. No. 5,669,620, teaches a wheel chair assembly and a seat transfer mechanism that the seat to move vertically and laterally. A scissor-jack can be used to raise and lower of base of the chair; however, the back of the chair does not recline relative to the base of the chair, the chair cannot be used as a manual wheelchair, and it cannot be collapsed when not in use.

K. H. Paulson, U.S. Pat. No. 3,123,400, teaches an invalid's chair that can be raised and lowered hydraulically using a scissors-type lifting element. Similar devices are shown in Allred, U.S. Pat. No. 5,800,016, Beard, et al., U.S. Pat. No. 5,601,302, Beck, U.S. Pat. No. 6,935,648, and S. D. Jacobson, U.S. Pat. No. 2,233,262 (which has a chair back that can be partially reclined). See also: Bergstrom, et al., U.S. Pat. No. 5,520,403, Branscumb, et al., U.S. Pat. No. 5,060,960, Axcess, EP 1 520 570, Pride Mobility Products, Corporation Exeter, EP 1 506 760, Bemotec GmbH, EP 1428 488, and Vassilli, EP 1,413,278.

The above-described references are hereby incorporated by reference in full.

The prior art teaches various forms of wheelchairs that can be used to raise and lower a patient. The prior art also teaches folding wheelchairs that can be folded for transportation and storage. However, the prior art does not teach a wheelchair that includes both features, both functioning to be vertically adjustable, and also folding for easy transportation and storage. The present invention fulfills these needs and provides further related advantages as described in the following summary.

### SUMMARY OF THE INVENTION

The present invention teaches certain benefits in construction and use which give rise to the objectives described below.

The present invention provides a vertically adjustable folding wheelchair comprising a pair of base elements, a pair of longitudinal frame members, and first and second telescoping elements. Each of a pair of rear wheels rotatably supports a rear portion of one of the pair of base elements. Each of a pair of front wheels rotatably supports a front portion of one of the pair of base elements. The first and second telescoping elements extending upwardly from each of the pair of base elements, and downwardly from each of the pair of longitudinal frame elements, to telescopically engage such that each of the pair of longitudinal frame members is positioned above one of the pair of base elements and can move vertically with respect thereto. A seat is supported by the pair of longitudinal frame members. A lifting element functions to move the pair of longitudinal frame members between a lowered configuration wherein the pair of longitudinal frame members are closer to the pair of base elements and the seat is in a lowered position, and a raised configuration wherein the pair of longitudinal frame members are further from the pair of base elements and the seat is in a raised position. Finally, a folding frame that supports the pair of base elements in a laterally spaced relationship, the folding frame folding between an expanded configuration wherein the pair of base elements are generally adjacent each other, and a folded configuration wherein the pair of base elements are laterally spaced apart from each other.

A primary objective of the present invention is to provide a vertically adjustable folding wheelchair having advantages not taught by the prior art.

Another objective is to provide a wheelchair that is adjustable vertically so that a patient can be easily raised and lowered.

A further objective is to provide a vertically adjustable wheelchair that can be folded laterally for easy portability and compact storage.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a front perspective view of a vertically adjustable folding wheelchair according to a preferred embodiment of the present invention, the view illustrating the wheelchair with the seat removed and rear wheels in phantom for clarity;

FIG. 2 is an exploded perspective view of a pair of base elements, a corresponding pair of longitudinal frame members, and pair of lifting elements therebetween that form the primary structural components of the wheelchair;

FIG. 3 is a side elevational view of one of the pair of base elements, along with its corresponding longitudinal frame member and lifting element, the longitudinal frame member and the lifting element being illustrated in a lowered configuration;

FIG. 4 is a side elevational view similar to FIG. 3, illustrating the longitudinal frame member and the lifting element in a raised configuration;

FIG. 5 is a perspective view of one embodiment of a folding frame that is adapted to be disposed between the pair of base elements;

FIG. 6 is a side perspective view of one of the pair of base elements illustrating a split tube that is adapted to support both the corresponding one of the pair of longitudinal frame members, and the folding frame;

FIG. 7 is a side perspective view of the wheelchair illustrating an alternative embodiment of the folding frame;

FIG. 8 is a front elevational view of the wheelchair illustrating a seat in a lowered, expanded configuration;

FIG. 9 is a front elevational view of the wheelchair illustrating the seat in a raised, expanded configuration;

FIG. 10 is a front elevational view of the wheelchair illustrating the seat in lowered, folded configuration; and

FIG. 11 is a perspective view of an alternative embodiment of the seat of the wheelchair.

### DETAILED DESCRIPTION OF THE INVENTION

The above-described drawing figures illustrate the invention, a vertically adjustable folding wheelchair 10 that is adapted to raise and lower a patient, and also fold down for easy portability and compact storage.

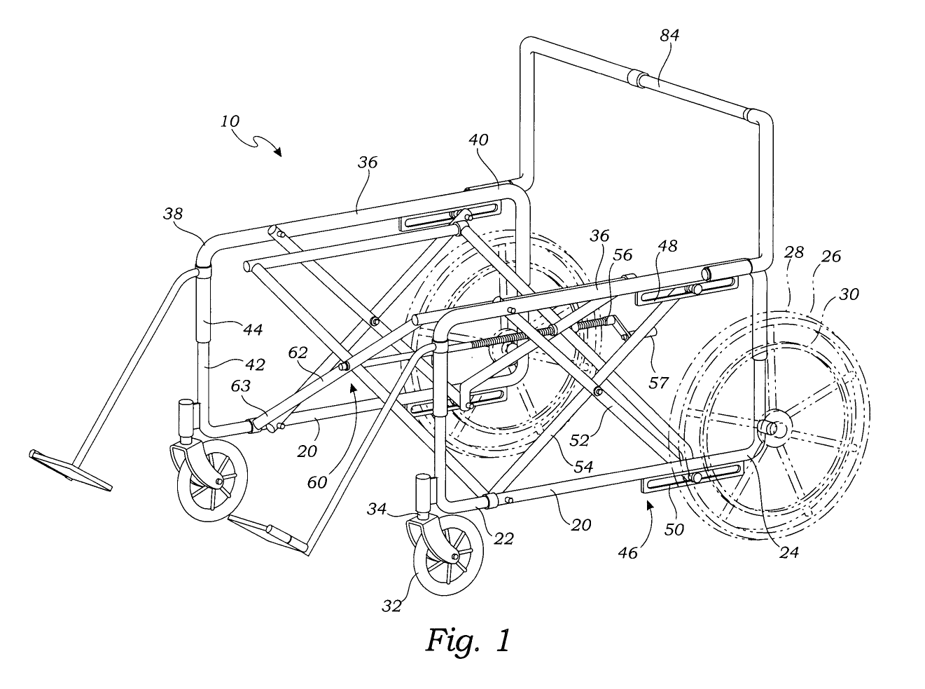

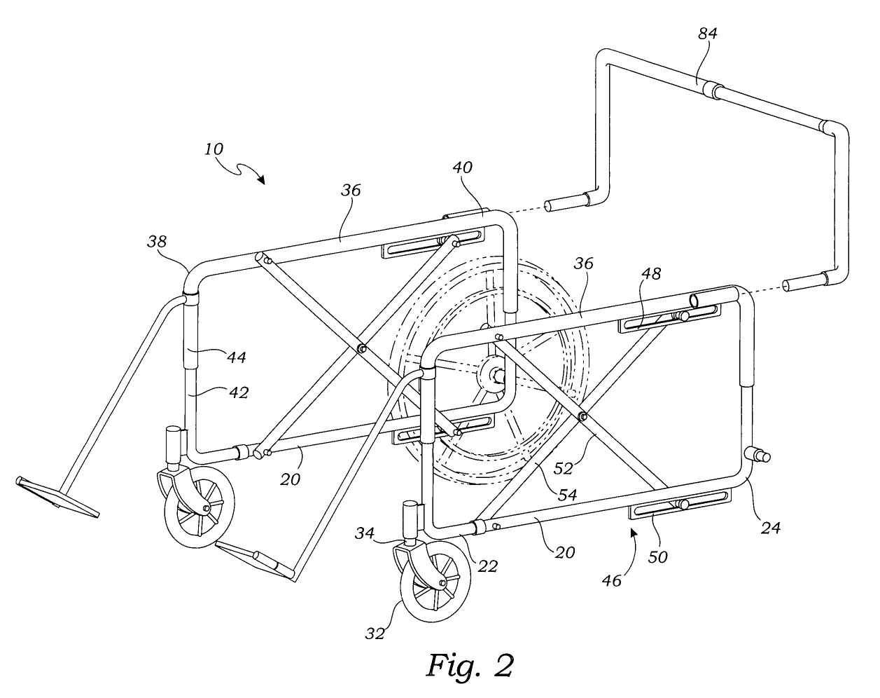

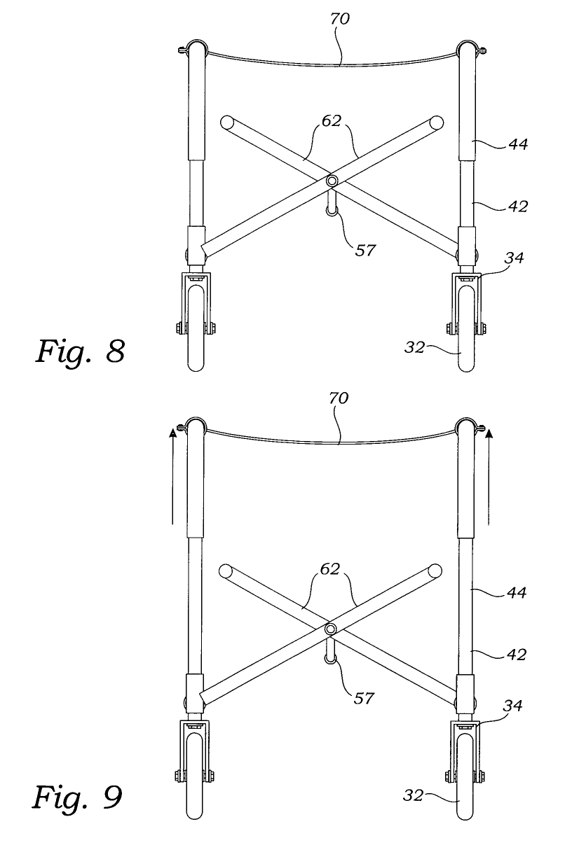

FIGS. 1 and 2 are perspective views of the vertically adjustable folding wheelchair 10 without a seat 70 (shown in FIGS. 8-10) and various other external components for more easily understanding the structure of the wheelchair 10, most particularly, illustrating a pair of base elements 20, a pair of longitudinal frame members 36, first and second telescoping elements 42 and 44, and a folding frame 60. FIG. 2 further does not show the folding frame 60 (which is best shown in FIG. 5), for ease of understanding of the other portions of the wheelchair 10.

As shown in FIGS. 1-4, the wheelchair 10 includes a pair of base elements 20 that are laterally spaced and function to provide a structural base for the wheelchair 10. Each of the pair of base elements 20 is strong, rigid, and durable element that is preferably an elongate tubular element having a front portion 22 and a rear portion 24. The pair of base elements 20 may be constructed of steel, aluminum, or similar suitable material known to those skilled in the art.

As shown in FIG. 1, a pair of rear wheels 26 (shown in phantom for clarity of structures behind the rear wheels 26) and a pair of front wheels 32 operably support the pair of base elements 20 for rolling motion. Each of the pair of rear wheels 26 rotatably supports the rear portion 24 of one of the pair of base elements 20, and each of the pair of front wheels 32 rotatably supports the front portion 22 of one of the pair of base elements 20. The pair of base elements 20 are preferably supported in a generally parallel relationship a short distance above the ground.

The rear wheels 26 are preferably generally similar to standard manual wheelchairs, and preferably include oversized rims 28 and a hand-rail 30 extending from the rims 28 to enable the user to propel and otherwise control the wheelchair 10. The front wheels 32 are preferably pivotally attached with a pivot-mount 34 to enable the wheelchair 10 to be more readily turned. Since both the front and rear wheels 32 and 26 are well known in the art, they are not described in greater detail herein.

As shown in FIGS. 1-4, the wheelchair 10 further includes a pair of longitudinal frame members 36. Each of the pair of longitudinal frame members 36 has a front portion 38 and a rear portion 40. Each of the pair of longitudinal frame members 36 is generally similar to the base elements 20, is constructed of a strong, rigid, and durable material such as tubular steel, aluminum, or the like, and is adapted to be positioned above one of the pair of base elements 20.

As shown in FIGS. 1-4, at least one first telescoping element 42 extends upwardly from each of the pair of base elements 20, and at least one second telescoping element 44 extending downwardly from each of the pair of longitudinal frame elements 36. Each of the second telescoping elements 44 telescopically engages one of the first telescoping elements 42 such that each of the pair of longitudinal frame members 36 is positioned above one of the pair of base elements 20 and can move vertically with respect thereto.

There are preferably two first telescoping elements 42 and two second telescoping elements 44. In the most preferred embodiment, each of the pair of base elements 20 and each of the pair of longitudinal frame members 36 are constructed of a tubular material that is generally U-shaped, and the ends of the base elements 20 and the longitudinal frame members 36 form the first and second telescoping elements 42 and 44. Obviously, those skilled in the art may devise alternative embodiments with different telescoping elements, different numbers of them, and different shapes, sizes, etc., and such alternatives should be considered within the scope of the claimed invention.

Those skilled in the art will recognize that there are structurally equivalent alternatives to telescopically engaging elements, including various forms of posts with tracks and runners, or various alternatives that are similar to or structurally equivalent to the presently preferred construction. For purposes of this application, the term telescopically engaging element is expressly defined to include these various alternatives and any other features that may be devised by those skilled in the art to simulate or replicate this feature of the present wheelchair 10.

As shown in the above-described figures, critical to the invention, the wheelchair 10 includes a lifting element 46, or preferably a pair of lifting elements 46, mounted between each of the pair of longitudinal frame members 36 and the corresponding one of the pair of base elements 20. The lifting element 46 functions to move the pair of longitudinal frame members 36 between a lowered configuration wherein the pair of longitudinal frame members 36 are closer to the pair of base elements 20 and the seat 70 is in a lowered position, and a raised configuration wherein the pair of longitudinal frame members 36 are further from the pair of base elements 20 and the seat 70 is in a raised position.

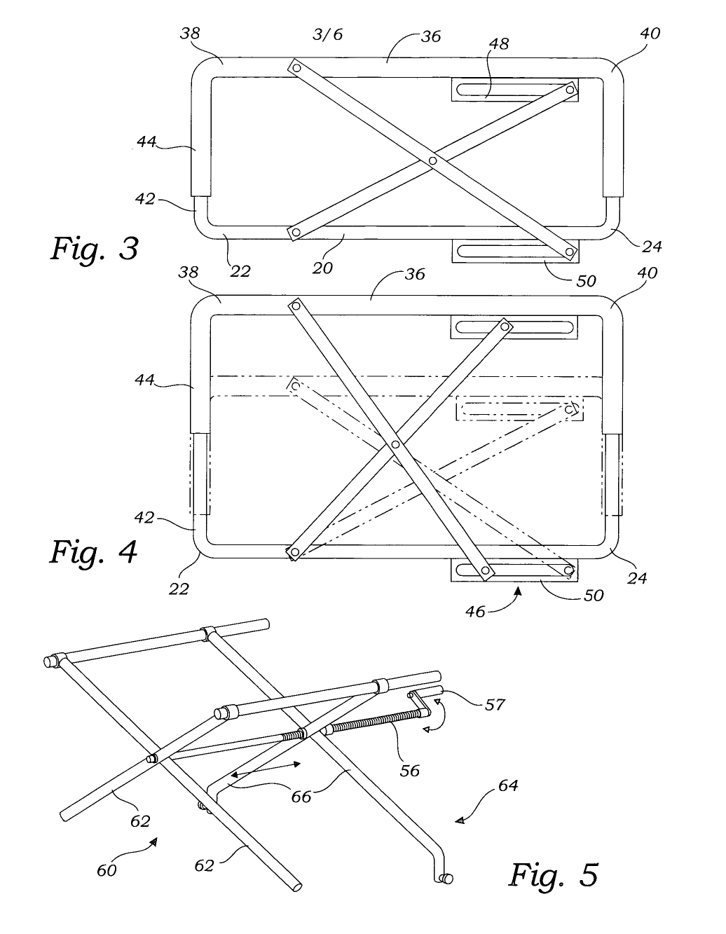

A shown in FIGS. 1-5, in the preferred embodiment each of the pair of lifting elements 46 includes first and second elongate lifting members 52 and 54 that function to raise and lower the pair of longitudinal frame members 36 with respect to the pair of base elements 20. As best shown in FIGS. 3 and 4, each of the pair of lifting elements 46 includes a top slider element 48 and a bottom slider element 50, each operably attached to one of the pair of base elements 20 and one of the pair of longitudinal frame members 36. The top slider element 48 is preferably formed on the rear portion 40 of the longitudinal frame member 36. The bottom slider element 50 is preferably formed on the rear portion 40 of one of the pair of base elements 20. Each of the pair of lifting elements 46 also includes a first elongate lifting member 52 and a second elongate lifting member 54. The first elongate lifting element 46 is preferably pivotally attached to the front portion 38 of the longitudinal frame member 36 and slidably engaged with the bottom slider element 50 such that the first elongate lifting element 46 can slide longitudinally with respect to the base element 20.

The second elongate lifting member 54 is pivotally attached to the front portion 22 of the base element 20 and slidably engaged with the top slider element 48 such that the second elongate lifting element 46 can slide longitudinally with respect to the longitudinal frame member 36. The first and second elongate lifting members 52 and 54 of each of the pair of lifting elements 46 are adapted to slide between a lowered configuration wherein the pair of longitudinal frame members 36 are closer to the pair of base elements 20 and the seat 70 is in a lowered position, and a raised configuration wherein the pair of longitudinal frame members 36 are further from the pair of base elements 20 and the seat 70 is in a raised position.

The lifting element 46 of this embodiment further includes a means for actuating the first and second elongate lifting elements 46 to move between the lowered and raised configurations. In one embodiment, the lifting element 46 is integrated with the folding frame 60, as described below. In another embodiment, the lifting element 46 is a hydraulic lift 58, as shown in FIG. 7. The means for actuating may also include any form of motor, actuator, lever, screw 56, or other mechanism know in the art for actuating the lifting elements 46 as described above, or in an equivalent manner. Such alternatives should be considered within the scope of the claimed invention.

FIG. 7 also illustrates another embodiment of the folding frame 60, wherein the folding frame 60 includes two pairs of cross-supports. Alternative embodiments of the folding frame 60 that may be developed by those skilled in the art are also considered within the scope of the claimed invention.

While the above-described structure forms the preferred embodiment of the lifting element(s) 46, those skilled in the art may devise various alternative mechanisms for lifting the longitudinal frame members 36, and such alternative structures should be considered within the scope of the claimed invention.

For example, the lifting element 46 may be a hydraulic lift 58 (similar to the one described above) that functions to actuate the base elements 20 and the longitudinal frame members 36, either directly, through the first and second telescoping elements 42 and 44, or in another manner. In other embodiments, he lift might be electric, mechanical, or other form of actuator, motor, lever, or lift, and these alternatives are expressly defined to be within the scope of the term lifting element 46.

As best shown in FIGS. 1 and 5, the wheelchair 10 further includes a folding frame 60 that supports the pair of base elements 20 in a laterally spaced relationship. The folding frame 60 folds between an expanded configuration wherein the pair of base elements 20 are generally adjacent each other, and a folded configuration wherein the pair of base elements 20 are laterally spaced apart from each other.

As shown in FIG. 5, the folding frame 60 preferably includes a pair of front lateral crossbars 62 that are pivotally connected and each pivotally attached at a lower end 63 to one of the pair of base elements 20. In a preferred embodiment, the folding frame 60 further includes a rear support structure 64 that is operably associated with each of the first elongate lifting members 52. In one embodiment, the rear support structure 64 includes a pair of rear lateral crossbars 66 that are similar to the pair of front lateral crossbars 62. In another embodiment, the rear support structure 64 may be a simple lateral support (not shown) that is capable of folding in some manner along with the pair of front lateral crossbars 62.

In this embodiment, as best shown in FIGS. 1 and 5, the folding frame 60 further includes elements of the lifting elements 46, described above. The folding frame 60 includes a folding actuator that is adapted to move the rear support structure 64 away from or towards the pair of front lateral crossbars 62, thereby moving each of the pair of lifting elements 46 between the lowered configuration and the raised configuration. In the preferred embodiment, the folding actuator is a screw 56 that is fixedly attached to the pair of front lateral crossbars 62 and threadedly engaged with the rear support structure 64. The screw 56 preferably includes a hand-crank 57 for rotating the screw 56 and moving the pair of lifting elements 46 between the lowered configuration and the raised configuration; however, in alternative embodiments, the screw 56 may be turned by a motor or other mechanism.

As shown in FIG. 7, the folding frame 60 might be constructed differently, and another embodiment is illustrated. Those skilled in the art will recognize that these are only two examples of many potential structures that could perform as described above, and such alternatives should be considered within the scope of the term folding frame 60.

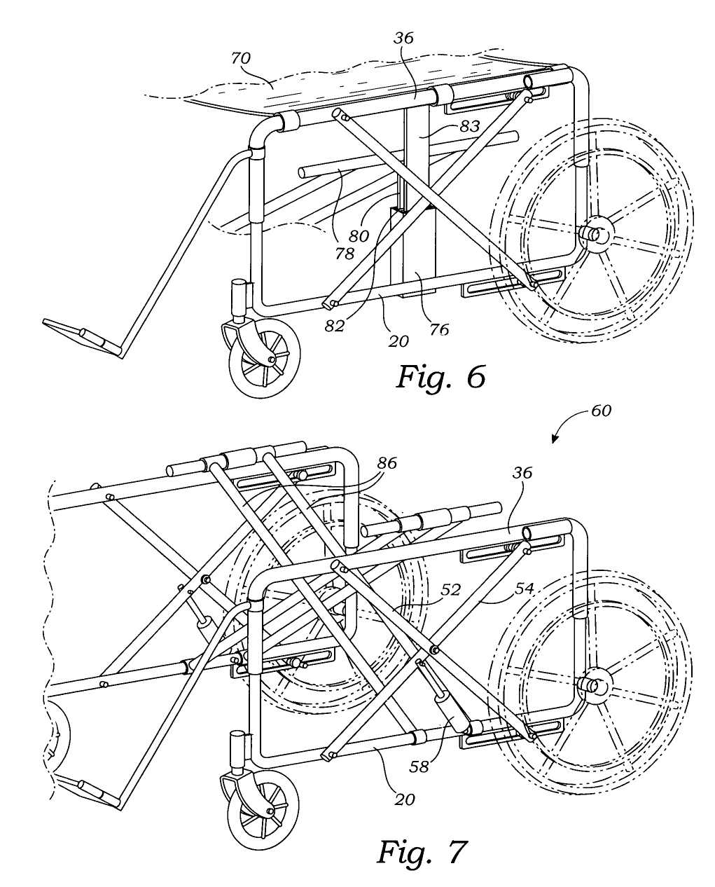

As shown in FIG. 6, the wheelchair 10 further includes a support structure 76 mounted on each of the pair of base elements 20 for slidably engaging the folding frame 60. In the preferred embodiment, the folding frame 60 includes connector-bars 78 that are attached to the front lateral crossbars 62 and slidably engage the rear support structure 64, and a sliding post 80 of the connector bar slidably engages a vertical chamber 82 of the support structure 76. In the most preferred embodiment, the support structure 76 is a split tube that is adapted to support both the corresponding one of the pair of longitudinal frame members 36 as well as the folding frame 60. A second post 83 preferably supports the longitudinal frame member 36 within the support structure 76.

As shown in FIGS. 6 and 8-10, a seat 70 is supported by the pair of longitudinal frame members 36. The seat 70 is adapted to fold along with the vertically adjustable folding wheelchair 10, as described in greater detail below. In one embodiment, as shown in FIGS. 8-10, the seat 70 is constructed of a flexible material to enable the proper folding.

In another embodiment, as shown in FIG. 11, the seat 70 may be constructed of two sections of a rigid material such as molded plastic, and the two sections fold with respect to one another along a hinged element 72. An interlocking element 74 lockingly engage a female element in the open configuration to lock the two sections in a generally planar configuration.

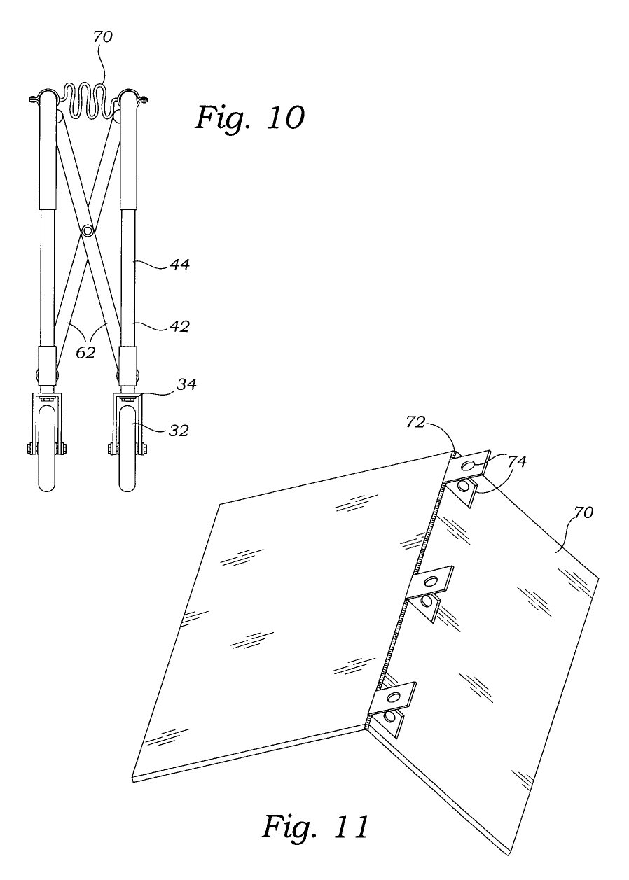

FIGS. 8-10 are front elevational views of the wheelchair 10 that best illustrate the various configurations of the wheelchair 10. For clarity, various components of the wheelchair 10 are not shown. FIG. 8 illustrates the seat 70 in the lowered position and the folding frame 60 in the expanded configuration. FIG. 9 illustrates the seat 70 in the raised position and the folding frame 60 in the expanded configuration. FIG. 10 illustrates the seat 70 in the lowered position and the folding frame 60 in the folded configuration, for easy transportation and storage of the wheelchair 10.

As shown in FIGS. 1 and 2, the wheelchair 10 includes a backrest 84. The backrest 84 may be telescoping, to enable the collapsing of the wheelchair 10, it may be removable, or it may have a flexible back (not shown), similar to the seat 70 (shown in FIG. 8-10), that enables folding of the wheelchair 10. The backrest 84 may also be adapted to recline (not shown), so that the wheelchair 10 can function in a manner similar to a stretcher.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A vertically adjustable folding wheelchair comprising:
a pair of base elements, each of the pair of base elements having a front portion and a rear portion;
a pair of rear wheels, each of the pair of rear wheels rotatably supporting the rear portion of one of the pair of base elements;
a pair of front wheels, each of the pair of front wheels rotatably supporting the front portion of one of the pair of base elements;
a pair of longitudinal frame members, each of the pair of longitudinal frame members having a front portion and a rear portion;
at least one first telescoping element extending upwardly from each of the pair of base elements;
at least one second telescoping element extending downwardly from each of the pair of longitudinal frame elements, each of the at least one second telescoping elements telescopically engaging one of the at least one first telescoping elements such that each of the pair of longitudinal frame members is positioned above one of the pair of base elements and can move vertically with respect thereto;
a seat supported by the pair of longitudinal frame members;
a lifting element that functions to move the pair of longitudinal frame members between a lowered configuration wherein the pair of longitudinal frame members are closer to the pair of base elements and the seat is in a lowered position, and a raised configuration wherein the pair of longitudinal frame members are further from the pair of base elements and the seat is in a raised position; and
a folding frame that supports the pair of base elements in a laterally spaced relationship, the folding frame folding between an expanded configuration wherein the pair of base elements are generally adjacent each other, and a folded configuration wherein the pair of base elements are laterally spaced apart from each other.

2. The vertically adjustable folding wheelchair of claim 1, wherein the folding frame includes a pair of front lateral crossbars that are pivotally connected and each pivotally attached at a lower end to one of the pair of base elements.

3. The vertically adjustable folding wheelchair of claim 2, wherein the lifting element includes a first elongate lifting member and a means for actuating the first elongate lifting member, and wherein the folding frame further includes a rear support structure that is operably associated with the first elongate lifting member.

4. The vertically adjustable folding wheelchair of claim 3, wherein the means for actuating includes a folding actuator that is adapted to move the rear support structure away from or towards the pair of front lateral crossbars, thereby moving each of the pair of lifting elements between the lowered configuration and the raised configuration.

5. The vertically adjustable folding wheelchair of claim 4, wherein the folding actuator is a screw that is fixedly attached to the pair of front lateral crossbars and threadedly engaged with the rear support structure.

6. The vertically adjustable folding wheelchair of claim 5, wherein the screw includes a hand-crank for rotating the screw and moving the pair of lifting elements between the lowered configuration and the raised configuration.

7. The vertically adjustable folding wheelchair of claim 6, wherein the folding actuator is a screw that is fixedly attached to the pair of front lateral crossbars and threadedly engaged with the rear support structure.

8. The vertically adjustable folding wheelchair of claim 1, wherein the seat is flexible.

9. The vertically adjustable folding wheelchair of claim 1, wherein the seat is rigid, and includes a hinged element and an interlocking element that locks the seat in a generally planar configuration.

10. The vertically adjustable folding wheelchair of claim 1, further comprising a support structure mounted on each of the pair of base elements for slidably supporting the folding frame.

11. A vertically adjustable folding wheelchair comprising:
a pair of base elements, each of the pair of base elements having a front portion and a rear portion;
a pair of rear wheels, each of the pair of rear wheels rotatably supporting the rear portion of one of the pair of base elements;
a pair of front wheels, each of the pair of front wheels rotatably supporting the front portion of one of the pair of base elements;
a pair of longitudinal frame members, each of the pair of longitudinal frame members having a front portion and a rear portion;
at least one first telescoping element extending upwardly from each of the pair of base elements;
at least one second telescoping element extending downwardly from each of the pair of longitudinal frame elements, each of the at least one second telescoping elements telescopically engaging one of the at least one first telescoping elements such that each of the pair of longitudinal frame members is positioned above one of the pair of base elements and can move vertically with respect thereto;
a seat supported by the pair of longitudinal frame members;
a pair of lifting elements mounted between each of the pair of longitudinal frame members and the corresponding one of the pair of base elements, each of the pair of lifting elements comprising:
a top slider element formed on the rear portion of the longitudinal frame member;
a bottom slider element formed on the rear portion of the base elements;
a first elongate lifting member pivotally attached to the front portion of the longitudinal frame member and slidably engaging the bottom slider element such that the first elongate lifting element can slide longitudinally with respect to the base element; and
a second elongate lifting member pivotally attached to the front portion of the base element and slidably engaging the top slider element such that the second elongate lifting element can slide longitudinally with respect to the longitudinal frame member,
wherein the first and second elongate lifting members of each of the pair of lifting elements slide between a lowered configuration wherein the pair of longitudinal frame members are closer to the pair of base elements and the seat is in a lowered position, and a raised configuration wherein the pair of longitudinal frame members are further from the pair of base elements and the seat is in a raised position; and
a means for actuating the first and/or second elongate lifting members of each of the pair of lifting elements between the lowered configuration and the raised configuration; and
a folding frame that supports the pair of base elements in a laterally spaced relationship, the folding frame folding between an expanded configuration wherein the pair of base elements are generally adjacent each other, and a folded configuration wherein the pair of base elements are laterally spaced apart from each other.

12. The vertically adjustable folding wheelchair of claim 11, wherein the folding frame includes a pair of front lateral crossbars that are pivotally connected and each pivotally attached at a lower end to one of the pair of base elements.

13. The vertically adjustable folding wheelchair of claim 12, wherein the folding frame further includes a rear support structure that is operably associated with each of the first elongate lifting members.

14. The vertically adjustable folding wheelchair of claim 13, wherein the means for actuating includes a folding actuator that is adapted to move the rear support structure away from or towards the pair of front lateral crossbars, thereby moving each of the pair of lifting elements between the lowered configuration and the raised configuration.

15. The vertically adjustable folding wheelchair of claim 14, wherein the folding actuator is a screw that is fixedly attached to the pair of front lateral crossbars and threadedly engaged with the rear support structure.

16. The vertically adjustable folding wheelchair of claim 15, wherein the screw includes a hand-crank for rotating the screw and moving the pair of lifting elements between the lowered configuration and the raised configuration.

17. The vertically adjustable folding wheelchair of claim 16, wherein the folding actuator is a screw that is fixedly attached to the pair of front lateral crossbars and threadedly engaged with the rear support structure.

18. The vertically adjustable folding wheelchair of claim 11, wherein the seat is flexible.

19. The vertically adjustable folding wheelchair of claim 11, wherein the seat is rigid, and includes a hinged element and an interlocking element that locks the seat in a generally planar configuration.

20. A vertically adjustable wheelchair comprising:
a pair of base elements, each of the pair of base elements having a front portion and a rear portion;
a pair of rear wheels, each of the pair of rear wheels rotatably supporting the rear portion of one of the pair of base elements;
a pair of front wheels, each of the pair of front wheels rotatably supporting the front portion of one of the pair of base elements;
a pair of longitudinal frame members, each of the pair of longitudinal frame members having a front portion and a rear portion;
at least one first telescoping element extending upwardly from each of the pair of base elements;
at least one second telescoping element extending downwardly from each of the pair of longitudinal frame elements, each of the at least one second telescoping elements telescopically engaging one of the at least one first telescoping elements such that each of the pair of longitudinal frame members is positioned above one of the pair of base elements and can move vertically with respect thereto;
a seat supported by the pair of longitudinal frame members;
a lifting element that functions to move the pair of longitudinal frame members between a lowered configuration wherein the pair of longitudinal frame members are closer to the pair of base elements and the seat is in a lowered position, and a raised configuration wherein the pair of longitudinal frame members are further from the pair of base elements and the seat is in a raised position; and
a frame that supports the pair of base elements in a laterally spaced relationship.
